(19) United States
(12) Patent Application Publication
(10) Pub. No.: US 2021/0163288 A1
(43) Pub. Date: Jun. 3, 2021

(54) HEXAGONAL BORON NITRIDE POWDER AND METHOD FOR PRODUCING HEXAGONAL BORON NITRIDE POWDER

(71) Applicant: DENKA COMPANY LIMITED, Tokyo (JP)

(72) Inventors: Go TAKEDA, Omuta-city (JP); Masao TSUICHIHARA, Omuta-city (JP); Yoshitaka TANIGUCHI, Omuta-city (JP)

(73) Assignee: DENKA COMPANY LIMITED, Tokyo (JP)

(21) Appl. No.: 17/265,841

(22) PCT Filed: Aug. 6, 2019
(86) PCT No.: PCT/JP2019/030983

§ 371 Date: Feb. 4, 2021

(30) Foreign Application Priority Data
Aug. 7, 2018 (JP) 2018-148504

(51) Int. Cl. C01B 21/064

(52) U.S. Cl. CPC C01B 21/0645; C01P 2004/61; C01P 2006/12

(57) ABSTRACT

A hexagonal boron powder having a purity of 98% by mass or more and a specific surface area of less than 2.0 m²/g.

### TECHNICAL FIELD

The present disclosure relates to hexagonal boron nitride (hBN) powder and a method for producing hexagonal boron nitride powder.

### BACKGROUND ART

Hexagonal boron nitride (hereinafter, simply referred to as “boron nitride”) has lubricating property, high thermal conductivity, insulation property, and the like. Therefore, boron nitride is widely used as solid lubricants, a mold release material for molten gases, aluminum, or the like, a filler for thermal radiation materials, and the like.

In particular, boron nitride powder to be used as a mold release material is required to be superior in mold release property and to have a small content of impurity elements such as a metal. With a current situation in which the mold shape is increasingly complicated and refined, the boron nitride powder to be used in semiconductors, electronic materials, and the like is required to have a smaller amount of metal impurities and higher mold release property than ever before. Furthermore, in order to improve mold release property, boron nitride powder having a small specific surface area is required.

The boron nitride powder is superior in high-temperature stability, thermal conductivity, lubricating property, and the like. Therefore, the boron nitride powder is mixed with water along with a dispersant such as carboxymethyl cellulose and sodium lignin sulfonate to prepare a slurry and this slurry has been used as a mold release material having lubricating property with respect to magnesium, aluminum, an aluminum alloy, and the like (for example, Patent Literature 1). In this case, it has also been known that liquid glass, a phosphoric salt, a nitrate salt, colloidal silica, and the like are further added to the slurry as mentioned above (for example, Patent Literature 2). However, metal elements remain in the mold release materials prepared by the methods as mentioned above, and thus it is difficult to use such mold release materials in specific use application such as semiconductors or electronic materials in some cases.

In a synthesis technique of boron nitride powder of the related art, a technique of adding a predetermined auxiliary agent to promote the grain growth of particles and thereby decreasing a specific surface area has been well known. As such an auxiliary agent, a compound containing an alkali metal or compound containing an alkali earth metal (for example, calcium or the like), a compound containing yttrium (for example, yttria or the like), or the like has been known (for example, Patent Literature 3).

Meanwhile, a method for producing a boron nitride fine particle without using an auxiliary agent has been known (for example, Patent Literature 4).

### CITATION LIST

### Patent Literature

Patent Literature 1: Japanese Unexamined Patent Publication No. S55-29506

Patent Literature 2: Japanese Unexamined Patent Publication No. S63-270798

Patent Literature 3: Japanese Unexamined Patent Publication No. 2016-60661

Patent Literature 4: International Publication WO 2015/122379

### SUMMARY OF INVENTION

### Technical Problem

However, in the case of synthesizing boron nitride powder by adding an auxiliary agent as mentioned above, a trace amount (50 ppm or more) of metals used in the auxiliary agent may remain as impurities in boron nitride powder to be obtained by firing raw material powder. Moreover, also in powder to be obtained by acid treatment (for example, hydrochloric acid treatment) of the above-described boron nitride powder, similarly, a trace amount (50 ppm or more) of metals used in the auxiliary agent may remain as impurities.

Furthermore, in synthesis of boron nitride powder without use of an auxiliary agent, although boron nitride powder with an extremely small amount of impurities can be obtained, the growth of primary particles is not necessarily sufficient, and thus a specific surface area of boron nitride powder to be obtained may be large.

As mentioned above, it cannot be said that a method for producing boron nitride powder which can sufficiently achieve both of a small specific surface area (a large particle diameter of micrometer order or more) and a high boron nitride purity is established.

An object of the present disclosure is to provide unprecedented boron nitride powder having a high purity and a small specific surface area. Also, another object of the present disclosure is to provide a method for producing the boron nitride powder as mentioned above.

### Solution to Problem

The present inventors have conducted intensive studies, and as a result, have found that, by heat-treating specific raw material powder under specific conditions, unprecedented boron nitride powder having a high purity and a small specific surface area may be synthesized, thereby completing the present invention based on the finding.

That is, an aspect of the present disclosure can provide the followings.

(1) Hexagonal boron powder having a purity of 98% by mass or more and a specific surface area of less than 2.0 m²/g.

(2) The hexagonal boron nitride powder described in (1), in which an average particle diameter is 2.0 to 30 μm.

(3) The hexagonal boron nitride powder described in (1) or (2), in which the hexagonal boron nitride powder contains an impurity metal and a content of the impurity metal is 35 ppm or less.

(4) The hexagonal boron nitride powder described in any one of (1) to (3), in which the hexagonal boron nitride powder contains an impurity metal and a content of the impurity metal is 20 ppm or less.

(5) The hexagonal boron nitride powder described in (3) or (4), in which the metal includes sodium, calcium, manganese, iron, and nickel.

(6) The hexagonal boron nitride powder described in any one of (1) to (5), in which the hexagonal boron nitride powder is used for a mold release material.

(7) A method for producing hexagonal boron nitride powder, the method including: a first step of heat-treating raw material powder containing a carbon-containing compound and a boron-containing compound in a gas atmosphere containing a compound having a nitrogen atom as a constituent element under a pressure of 0.25 MPa or more and less than 5.0 MPa at a temperature of 1600° C. or higher and lower than 1850° C. to obtain a heat-treated product; and a second step of firing the heat-treated product at a temperature higher than the temperature of the first step to obtain hexagonal boron nitride powder.

(8) The method described in (7), in which the first step is performed over 2 hours or longer.

(9) The method described in (7) or (8), in which a heating temperature of the second step is 1850° C. to 2050° C.

### Advantageous Effects of Invention

According to the present disclosure, it is possible to provide unprecedented boron nitride powder having a high purity and a small specific surface area. According to the present disclosure, it is also possible to provide a method for producing the boron nitride powder as mentioned above.

### DESCRIPTION OF EMBODIMENTS

In the present specification, a numerical range expressed by “◯◯ to ΔΔ” means “◯◯ or more and ΔΔ or less” unless otherwise specified. “Part” or “%” in the present specification is on a mass basis unless otherwise specified. Furthermore, the unit of pressure in the present specification is gauge pressure unless otherwise specified, and the notation such as “G” or “gage” will be omitted.

Boron nitride powder of the present disclosure is preferably used as a mold release material. That is, the boron nitride powder of the present disclosure may be used for a mold release material. For example, a slurry containing the boron nitride powder, a dispersant, and a solvent is prepared, the slurry is sprayed or applied to a mold to form a film, a solvent content of the film is then decreased, and thereby the film can be used for forming a mold release layer. A target of formation of the mold release layer is not limited to a mold as mentioned above, and an article molded by a mold (a product to be released) can also be regarded as a target. Since the above-described mold release layer is superior in mold release property, a product superior in quality may be provided. Materials constituting the above-described mold and the above-described article contain, for example, at least one selected from ceramics, a metal, and the like. Materials constituting the above-described mold and the above-described product may be different from or the same as each other.

<Boron Nitride Powder>

An embodiment of the hexagonal boron nitride powder has a purity of 98% by mass or more and a specific surface area of less than 2.0 m²/g. The above-described boron nitride powder has unprecedented features that a purity is high and a specific surface area is small.

The purity of the boron nitride powder is 98% by mass or more and preferably 99% by mass or more. In a case where the purity is too low, low-melting-point impurities such as boron oxide exist, and due to this existence of impurities, there is a concern that mold release property is degraded, for example, when the boron nitride powder is used at a high temperature.

The specific surface area of the boron nitride powder (the specific surface area of primary particles of boron nitride) is less than 2.0 m²/g, preferably 1.5 m²/g or less, and more preferably 0.8 m²/g or less. From the viewpoint that a dense mold release layer is easily generated when the boron nitride powder is used as a mold release material, the specific surface area is desirably small. When the specific surface area of the boron nitride powder is too large, there is a concern that mold release property becomes insufficient. The lower limit value of the specific surface area of the boron nitride powder is not particularly limited, and is preferably 0.2 m²/g or more. Since it is necessary to lengthen the heat treatment time of the raw material powder in order to obtain boron nitride having a specific surface area of less than 0.2 m²/g, there is a tendency that production of boron nitride becomes industrially difficult.

The average particle diameter of the boron nitride powder (the average particle diameter of primary particles of boron nitride) is preferably 2.0 μm or more and more preferably 4.0 μm or more. When the lower limit value of the average particle diameter of the boron nitride powder is within the above-described range, the mold release property of a mold release layer may be made more sufficient while a dense mold release layer is formed. The average particle diameter of the boron nitride powder is preferably 30 μm or less, more preferably less than 30 μm, further preferably 25 μm or less, and further more preferably less than 25 μm. When the upper limit value of the average particle diameter of the boron nitride powder is within the above-described range, degradation in adhesion between a mold release layer and a mold may be suppressed. The average particle diameter of the boron nitride powder can be adjusted within the aforementioned range, and may be, for example, 2.0 to 30 μm and 4.0 to 25 μm.

In a case where the boron nitride powder contains an impurity such as a metal, it is difficult to use the boron nitride powder in use application such as semiconductors or electronic materials in some cases. Therefore, even in the case of boron nitride powders having the same purity, boron nitride powder having small impurities such as a metal is more desirable. The content of the metal in the boron nitride powder is preferably 35 ppm or less, more preferably 20 ppm or less, and particularly preferably 10 ppm or less. When the content of the metal in the boron nitride powder is within the above-described range, for example, degradation in quality caused by poor appearance due to color unevenness, poor performance of insulation characteristics, etc., and the like may be suppressed. In other words, when the content of the metal in the boron nitride powder is within the above-described range, high-quality semiconductors, electronic materials, and the like may be provided. The type of the above-described metal is not particularly limited, and is generally alkali metals such as sodium, alkali earth metals such as calcium, transition elements such as manganese, iron, and nickel, and the like. The above-described metal may include, for example, at least one selected from the group consisting of sodium, calcium, manganese, iron, and nickel.

More specifically, the total content of sodium, calcium, manganese, iron, and nickel in the boron nitride powder is preferably 35 ppm or less, more preferably 20 ppm or less, and particularly preferably 10 ppm or less. When the total content of sodium, calcium, manganese, iron, and nickel in the boron nitride powder is within the above-described range, for example, degradation in quality caused by poor appearance due to color unevenness, poor performance of insulation characteristics, etc., and the like may be further suppressed. In other words, when the total content of sodium, calcium, manganese, iron, and nickel in the boron nitride powder is within the above-described range, higher-quality semiconductors, electronic materials, and the like may be provided.

In a case where the boron nitride powder contains agglomerated powder, since there is a tendency that the mold release property of a mold release layer to be formed using the boron nitride powder is degraded, the content of the agglomerated powder is preferably small. The content of the agglomerated powder in the boron nitride powder may be, for example, 8% by mass or less or 3% by mass or less. It is further preferable that the boron nitride powder does not contain agglomerated powder.

The boron nitride powder preferably has a purity of 98% by mass or more, a specific surface area of less than 2.0 m²/g, an average particle diameter of 2.0 μm or more, and a metal content of 35 ppm or less.

<Method for Producing Boron Nitride Powder>

An embodiment of a method for producing boron nitride powder has a first step of heat-treating raw material powder containing a carbon-containing compound (carbon raw material) and a boron-containing compound in a gas atmosphere containing a compound having a nitrogen atom as a constituent element (also referred to as a nitrogen-containing gas atmosphere) under a pressure of 0.25 MPa or more and less than 5.0 MPa at a temperature of 1600° C. or higher and lower than 1850° C. to obtain a heat-treated product, and a second step of firing the heat-treated product at a temperature higher than the temperature of the first step to obtain hexagonal boron nitride powder.

The above-described method for producing boron nitride powder is a producing method to which a so-called carbon reduction method is applied. This producing method has the aforementioned configuration, and thereby boron nitride powder having a high purity and a low specific surface area may be produced. Incidentally, the aforementioned producing method to which a carbon reduction method is applied is suitable for obtaining boron nitride powder having a low specific surface area since thick primary particles are synthesized as compared to other methods of synthesizing boron nitride using melamine borate or the like as other raw materials.

The first step is a step of pressurizing and heating raw material powder in the presence of a compound having a nitrogen atom as a constituent element to produce boron nitride. The second step is a step of continuously further pressurizing and heating the heat-treated product at a high temperature in the presence of a compound having a nitrogen atom as a constituent element to grow and further decarburize primary particles of scale-like boron nitride. The raw material powder, conditions of each step, and the like will be described below.

The carbon-containing compound (carbon raw material) is a compound having a carbon atom as a constituent element and is a compound that forms boron nitride by reaction with a boron-containing compound and a compound having a nitrogen atom as a constituent element. In the aforementioned producing method, it is desirable to use a raw material having a high purity and being relatively inexpensive, and examples of the carbon-containing compound include carbon black and acetylene black.

The boron-containing compound is a compound having boron as a constituent element and is a compound that forms boron nitride by reaction with a carbon-containing compound and a compound having a nitrogen atom as a constituent element. In the aforementioned producing method, it is desirable to use a raw material having a high purity and being relatively inexpensive, and examples of the boron-containing compound include boric acid and boron oxide. In the case of using boric acid as the boron-containing compound, it is desirable to perform dehydration of boric acid in advance in order to maximize the yield of boron nitride to be obtained, and from the same reason, it is desirable that boric acid is used as a high-density raw material by performing molding before firing.

The compound having a nitrogen atom as a constituent element is a compound that forms boron nitride by reaction with a carbon-containing compound and a boron-containing compound. The compound having a nitrogen atom as a constituent element is generally supplied in the form of gas. Examples of the compound having a nitrogen atom as a constituent element include nitrogen and ammonia. Examples of gas containing the compound having a nitrogen atom as a constituent element (also referred to as nitrogen-containing gas) include nitrogen gas, ammonia gas, and mixed gas thereof. From the viewpoint of promoting the formation of boron carbonitride by a nitriding reaction and the viewpoint of cost, the nitrogen-containing gas preferably includes nitrogen gas and more preferably is nitrogen gas. In the case of using mixed gas as the nitrogen-containing gas, the proportion of nitrogen gas is preferably 95 volume/volume % or more.

The raw material powder may contain other compounds in addition to the carbon-containing compound and the boron-containing compound. Examples of other compounds include boron nitride powder as a nucleating agent. When the raw material powder contains boron nitride powder as a nucleating agent, the average particle diameter of the boron nitride powder to be synthesized may be more easily controlled. The raw material powder preferably contains a nucleating agent. When the raw material powder contains a nucleating agent, the adjustment of the specific surface area is facilitated, and boron nitride powder having a specific surface area of 0.2 to 0.8 m²/g may be more easily produced.

In the case of using boron nitride powder as a nucleating agent, the content of the boron nitride powder as a nucleating agent may be, for example, 0.05 to 8 parts by mass based on 100 parts by mass of the raw material powder. When the content of the boron nitride powder as a nucleating agent is 0.05 parts by mass or more, the effect as a nucleating agent may be made more sufficient. When the content of the boron nitride powder as a nucleating agent is 8 parts by mass or less, a decrease in yield of the boron nitride powder may be suppressed.

The first step and the second step in the method for producing boron nitride powder are performed in a pressurized environment. The pressure in the first step and the second step is 0.25 MPa or more and less than 5.0 MPa. In a case where the pressure in the first step and the second step is less than 0.25 MPa, boron carbide is generated as a by-product and the specific surface area of boron nitride powder to be obtained is increased, which is not preferable. In a case where the pressure in the first step and the second step is 5.0 MPa or more, the cost of the furnace itself is increased and boron oxide is hardly volatilized, so that firing for a further longer time is needed, which is disadvantageous in terms of industrial aspect. The pressure in the first step and the second step is preferably 0.25 MPa or more and 1.0 MPa or less and more preferably 0.25 MPa or more and less than 1.0 MPa, from an economic viewpoint.

The heating temperature in the first step is 1600° C. or higher and lower than 1850° C. and preferably 1650° C. to 1800° C. The heating time in the first step may be, for example, 2 hours or longer and 3 hours or longer. The heating time in the first step may be, for example, 10 hours or shorter. When the heating temperature and the heating time in the first step are within the above-described ranges, generation of a by-product may be more sufficiently suppressed. The temperature increasing rate in the first step is not particularly limited, and may be, for example, a low rate such as 0.5° C./min.

The heating temperature in the second step is set to be a temperature higher than that in the first step. The heating temperature in the second step may be, for example, 1850° C. to 2050° C. and 1900° C. to 2025° C. When the heating temperature in the second step is set within the above-described range, boron nitride powder having a smaller specific surface area may be adjusted. When the lower limit value of the heating temperature in the second step is set to 1850° C. or higher, the growth of primary particles is made sufficient, and thereby the specific surface area may be further increased. When the upper limit value of the heating temperature in the second step is set to 2050° C. or lower, yellowing of the boron nitride powder is suppressed, and thus deterioration in appearance may be suppressed.

The heating time (high-temperature firing time) in the second step may be, for example, 0.5 hours or longer and 1 hour or longer. When the heating time in the second step is set to 0.5 hours or longer, the growth of primary particles may be made more sufficient. The heating time in the second step may be, for example, 30 hours or shorter and 25 hour or shorter, from an economic viewpoint.

The method for producing boron nitride powder may have other steps in addition to the first step and the second step. Examples of the other steps include a step of performing dehydration of the raw material powder before the first step and a step of performing compression molding of the raw material powder before the first step. By the method for producing boron nitride powder further having the step of performing dehydration, the step of performing compression molding, and the like, generation of volatiles derived from the boron-containing compound and the like in the raw material powder is suppressed, contamination or the like caused by attachment, fusion, or the like of the volatiles to the inside of the furnace may be suppressed, and thus a load of the furnace body may be reduced.

Hereinbefore, several embodiments have been described, but the present disclosure is not intended to be limited to the above-described embodiment at all. Furthermore, the contents of description of the embodiments mentioned above can be applied to each other.

### EXAMPLES

Hereinafter, the present disclosure will be described in more detail by using Examples and Comparative Examples. Incidentally, the present disclosure is not limited to the following Examples.

Various measurement methods are as follows.

(1) Average Particle Diameter of Boron Nitride Powder

The average particle diameter of the boron nitride powder (the average particle diameter of primary particles of boron nitride) was measured by using a particle size distribution meter (manufactured by NIKKISO CO., LTD., trade name: MT3300EX) according to ISO 13320:2009. Furthermore, the average particle diameter thus obtained is an average particle diameter based on the volume statistical value. The average particle diameter thus obtained is a median value (d50). When the particle size distribution was measured, water was used as a solvent of dispersing the aggregate and hexametaphosphoric acid was used as a dispersant. In this case, numerical values of 1.33 and 1.80 were used as a refractive index of water and a refractive index of the boron nitride powder, respectively.

(2) Purity of Boron Nitride Powder

The purity of the boron nitride powder was obtained by the following method. Specifically, a sample was subjected to an alkaline decomposition with sodium hydroxide, and ammonia was distilled out by a steam distillation method for collection in an aqueous solution of boric acid. This collected liquid was titrated with a sulfuric acid normal solution to obtain the content of nitrogen atom (N). Thereafter, the content of boron nitride (BN) in the sample was determined based on the following Equation (1), and the purity of the boron nitride powder was calculated. Incidentally, the formula weight of boron nitride used was 24.818 g/mol, and the atomic weight of the nitrogen atom used was 14.006 g/mol.

Content [% by mass] of boron nitride (BN) in the sample=Content [% by mass] of nitrogen atom (N)×1.772 (1)

(3) Specific Surface Area of Boron Nitride Powder

The specific surface area of the aggregate of primary particles of boron nitride was measured by using a measurement apparatus according to JIS Z 8803:2013. The specific surface area is a value calculated by applying a BET single-point method using nitrogen gas.

(4) Metal Content of Boron Nitride Powder

The metal content of the boron nitride powder was measured by a pressure acid decomposition method of ICP emission spectrometry. A value of a metal element having the largest content among the analyzed metals (sodium, calcium, manganese, iron, and nickel) was regarded as the metal content.

### Example 1

In Example 1, boron nitride powder was synthesized as follows.

Mixed powder (raw material powder) was obtained by mixing 100 parts by mass of boric acid (manufactured by Kojundo Chemical Laboratory Co., Ltd.) and 25 parts by mass of acetylene black (manufactured by Denka Company Limited, grade name: HS100) by using a Henschel mixer. The mixed powder thus obtained was put in a dryer set at 250° C. and held for 3 hours to perform dehydration of boric acid. 200 g of the mixed powder obtained after dehydration was put in a mold having a diameter of 100Φ of a press molding machine and molded under conditions of a heating temperature of 200° C. and a press pressure of 30 MPa. The molded body of the raw material powder obtained in this way was used in firing.

The above-described molded body was left to stand still in a carbon atmosphere furnace, the temperature was increased to 1800° C. at a temperature increasing rate of 5° C./min in a nitrogen atmosphere pressurized at 0.8 MPa and held at 1800° C. for 3 hours, and then the heating treatment of the above-described molded body was performed (the first step). Thereafter, the temperature inside the carbon atmosphere furnace was further increased to 2000° C. at a temperature increasing rate of 5° C./min and held at 2000° C. for 7 hours, and the heat-treated product of the above-described molded body was fired at a high temperature (the second step). The loosely aggregated boron nitride obtained after firing was crushed by a Henschel mixer and passed through a sieve having a mesh opening of 75 μm. The powder passed through the sieve was used as boron nitride powder of Example 1. The purity, the specific surface area, the average particle diameter, and the metal content of the boron nitride powder thus obtained were measured and the results thereof were shown in Table 1.

(5) Mold Release Property Evaluation

The performance (mold release property) as a mold release material of the boron nitride powder obtained as mentioned above was evaluated. First, a molded body as a target to which a mold release material was applied was prepared as follows. 2.5 mol % of yttria was added to silicon nitride powder having an oxygen amount of 1.0% and a specific surface area of 10 m²/g, methanol was added thereto, and the resultant product was wet-mixed for 5 hours with a wet ball mill, thereby obtaining a mixture. The mixture thus obtained was filtered, and the filtered product was dried, thereby obtaining mixed powder. The above-described mixed powder was filled in a mold, molding was performed in the mold at a molding pressure of 20 MPa, and then CIP molding was performed at a molding pressure of 200 MPa, thereby preparing a plate-shaped molded body (5 mm×50 mm×50 mm)

Subsequently, the boron nitride powder obtained as mentioned above was dispersed in a normal hexane solution to prepare a slurry with a concentration of 1% by mass. The slurry thus prepared was applied to both surfaces of the above-described molded body so that the thickness on the aforementioned molded body became 10 μm, and the slurry was dried, thereby preparing a base material provided with a mold release layer. By the same method, thirty base materials were prepared and these thirty base materials were stacked, thereby preparing a block. This block was left to stand still in an electric furnace having a carbon heater and then fired for 6 hours under conditions of 1900° C. and 0.9 MPa. The peeled surfaces of the above-described base materials obtained after firing were observed by visual inspection, and mold release property was evaluated based on the following criteria. “A” means that mold release property is most superior.

A: All base materials were naturally released, and black spots derived from impurities and the like were not recognized in the peeled surfaces of the base materials.

B: All base materials were naturally released, and black spots derived from impurities and the like were slightly recognized in the peeled surfaces of the base materials.

C: The base materials were not released from each other or black spots derived from impurities and the like were recognized in the peeled surfaces of the base materials.

### Example 2

In Example 2, boron nitride powder was produced in the same manner as in Example 1, except that the heating temperature in the second step was set to 1900° C.

### Example 3

In Example 3, boron nitride powder was produced in the same manner as in Example 1, except that the pressure in the first step and the second step was set to 0.3 MPa.

### Example 4

In Example 4, boron nitride powder was produced in the same manner as in Example 1, except that 1 part by mass of boron nitride (manufactured by Denka Company Limited, grade name: GP) was further blended as a nucleating agent in the raw material powder of Example 1.

### Example 5

In Example 5, boron nitride powder was produced in the same manner as in Example 1, except that the boron nitride powder obtained in Example 1 was further subjected to jet mill pulverization by using a jet mill (manufactured by DAIICHI JITSUGYO CO., LTD., trade name: PJM-80) under a pulverization condition of a pulverization pressure of 0.2 MPa.

### Example 6

In Example 6, boron nitride powder was produced in the same manner as in Example 1, except that 10 parts by mass of boron nitride (manufactured by Denka Company Limited, grade name: SGP) was further blended as a nucleating agent in the raw material powder of Example 1 and the heating time in the second step was set to 40 hours.

### Comparative Example 1

Commercially available boron nitride powder was used as Comparative Example 1. The evaluation of the boron nitride powder of Comparative Example 1 was shown in Table 2.

### Comparative Example 2

In Comparative Example 2, boron nitride powder was produced in the same manner as in Example 1, except that the heating temperature in the second step was changed from 2000° C. to 1800° C. The evaluation of the boron nitride powder of Comparative Example 2 was shown in Table 2.

### Comparative Example 3

In Comparative Example 3, boron nitride powder was produced in the same manner as in Example 1, except that the pressure in the first step and the second step was set to 0.2 MPa. The evaluation of the boron nitride powder of Comparative Example 3 was shown in Table 2. Incidentally, the degree of contamination inside the furnace was large under the producing condition of Comparative Example 3 as compared to Example 1.

TABLE 1

| | | Example | Example | Example | Example | Example | Example |
|---|---|---|---|---|---|---|---|
| | | 1 | 2 | 3 | 4 | 5 | 6 |
| Boron nitride | Purity | 99 | 98 | 99 | 99 | 99 | 99 |
| powder | [% by mass] | | | | | | |
| | Specific surface | 1.3 | 1.3 | 1.9 | 0.5 | 1.9 | 0.1 |
| | area [m²/g] | | | | | | |
| | Average particle | 9.2 | 9.5 | 9.3 | 20 | 4.5 | 35 |
| | diameter [μm] | | | | | | |
| | Metal content | 5 | 5 | 5 | 5 | 5 | 5 |
| | [ppm] | | | | | | |
| Evaluation | Mold release | A | A | A | A | A | B |
| | property | | | | | | |

TABLE 2

| | | Comparative | Comparative | Comparative |
|---|---|---|---|---|
| | | Example 1 | Example 2 | Example 3 |
| Boron | Purity | 98 | 96 | 99 |
| nitride | [% by mass] | | | |
| powder | Specific surface | 6.0 | 1.3 | 2.5 |
| | area [m²/g] | | | |
| | Average particle | 8.2 | 9.5 | 9.1 |
| | diameter [μm] | | | |
| | Metal content | 30 | 5 | 5 |
| | [ppm] | | | |
| Evaluation | Mold release | C | C | C |
| | property | | | |

### INDUSTRIAL APPLICABILITY

According to the present disclosure, it is possible to provide unprecedented boron nitride powder having a high purity and a small specific surface area. According to the present disclosure, it is also possible to provide a method for producing the boron nitride powder as mentioned above.

1. A hexagonal boron nitride powder having a purity of 98% by mass or more and a specific surface area of less than 2.0 m²/g.

2. The hexagonal boron nitride powder according to claim 1, wherein an average particle diameter is 2.0 to 30 μm.

3. The hexagonal boron nitride powder according to claim 1, wherein the hexagonal boron nitride powder contains a metal and a content of the metal is 35 ppm or less.

4. The hexagonal boron nitride powder according to claim 1, wherein the hexagonal boron nitride powder contains a metal and a content of the metal is 20 ppm or less.

5. The hexagonal boron nitride powder according to claim 3, wherein the metal includes at least one selected from the group consisting of sodium, calcium, manganese, iron, and nickel.

6. The hexagonal boron nitride powder according to claim 1, wherein the hexagonal boron nitride powder is used for a mold release material.

7. A method for producing hexagonal boron nitride powder, the method comprising:
a first step of heat-treating raw material powder containing a carbon-containing compound and a boron-containing compound in a gas atmosphere containing a compound having a nitrogen atom as a constituent element under a pressure of 0.25 MPa or more and less than 5.0 MPa at a temperature of 1600° C. or higher and lower than 1850° C. to obtain a heat-treated product; and
a second step of firing the heat-treated product at a temperature higher than the temperature of the first step to obtain hexagonal boron nitride powder.

8. The method according to claim 7, wherein the first step is performed over 2 hours or longer.

9. The method according to claim 7, wherein a heating temperature of the second step is 1850° C. to 2050° C.
